(19) United States
(12) Patent Application Publication
(10) Pub. No.: US 2017/0053723 A1
(43) Pub. Date: Feb. 23, 2017

(54) MAGNETS INCLUDING AN ALUMINUM MANGANESE ALLOY COATING LAYER AND RELATED METHODS

(71) Applicant: Xtalic Corporation, Marlborough, MA (US)

(72) Inventors: Alan C. Lund, Framingham, MA (US); Robert Hilty, Walpole, MA (US); Lawrence Masur, Needham, MA (US); Shiyun Ruan, Arlington, MA (US); Jason Reese, Londonderry, NH (US)

(73) Assignee: Xtalic Corporation, Marlborough, MA (US)

(21) Appl. No.: 15/241,739

(22) Filed: Aug. 19, 2016

Related U.S. Application Data
(60) Provisional application No. 62/207,889, filed on Aug. 20, 2015.

(51) Int. Cl. H01F 1/057; C22C 38/00; C23C 28/02; C25D 5/36; C25D 5/48; C23C 30/00; C22C 21/00; C25D 3/56

(52) U.S. Cl. CPC H01F 1/057; C22C 21/00; C22C 38/005; C22C 38/002; C25D 3/56; C25D 5/36; C25D 5/48; C23C 30/005; C23C 28/021

(57) ABSTRACT

Magnets including a coating and related methods are described herein. The coating may include an aluminum manganese alloy layer. The aluminum manganese alloy layer may be formed in an electroplating process.

### RELATED APPLICATIONS

This application claims priority to U.S. Provisional Application No. 62/207,889, filed Aug. 20, 2015, which is incorporated herein by reference in its entirety.

### FIELD OF INVENTION

The present invention generally relates to magnets including an aluminum manganese coating layer and related methods (e.g., electroplating methods).

### BACKGROUND OF INVENTION

Magnets are used in numerous applications. Some magnetic materials (e.g., rare earth magnetic materials) are prone to corrosion and/or brittleness when used in certain applications. Such corrosion and/or brittleness can negatively impact their performance and efficacy. Accordingly, technical solutions that can mitigate the corrosion and brittleness problems associated with such magnets are desirable.

### SUMMARY OF INVENTION

Magnets including a coating and related methods are described herein.

In one aspect, an article is provided. The article comprises a magnet and a coating formed on the magnet. The coating includes an aluminum manganese alloy layer including a manganese concentration of less than or equal to 12 atomic %.

In another aspect, a method of forming a coating on an article is provided. The method comprises electroplating a coating on a magnet. The coating includes an aluminum manganese alloy layer including a manganese concentration of less than or equal to 12 atomic %.

Other aspects, embodiments, and features of the invention will become apparent from the following detailed description. All patent applications and patents incorporated herein by reference are incorporated by reference in their entirety. In case of conflict, the present specification, including definitions, will control.

### BRIEF DESCRIPTION OF DRAWINGS

FIG. 1 shows the true stress vs. true strain curve for the samples described in Example 1.

### DETAILED DESCRIPTION

Magnets including a coating and related methods are described herein. The coating may include an aluminum manganese alloy layer. As described further below, the aluminum manganese alloy layer may have a manganese concentration of less than or equal to 12 atomic % (e. g., between 0.5 atomic % and 12 atomic %). The aluminum manganese alloy layer may be formed in an electroplating process. In some embodiments, the magnets comprise rare earth magnetic material (e.g., NdFeB-based materials). The coated magnets may be used in a variety of applications including in portable electronic devices. The coatings impart the magnets with desirable properties including corrosion resistance and ductility.

In general, the magnet may comprise any suitable magnetic material. Magnetic materials that are prone to corrosion and/or brittleness may be particularly well-suited for use in the embodiments described herein. In some cases, the magnet comprises a rare earth magnetic material. For example, the rare earth magnetic material may comprise neodymium; and, in some cases, the rare earth magnetic material further comprises iron and boron, in addition to neodymium. For instance, the rare earth magnetic material may be a NdFeB-based material such as Nd₂Fe₁₄B and Nd₉Fe₈₆B₅. Other rare earth magnetic materials are also suitable including SmCo₅, AlNiCo, and NiFe, amongst others. In some embodiments, the magnetic material may not be a rare earth magnetic material. For example, the magnetic material may be an AlNiCo material (e.g., comprising Al (8-12 atomic %), Ni (15-16 atomic %), Co (5-24 atomic %), Cu (<6 atomic %), Ti (<1 atomic %), balance Fe) or a NiFe material (e.g., materials having a L10 crystal structure, 50 at % Fe-50 at % Ni).

The magnet may have a variety of different shapes and sizes. For instance, the magnet may be a block, a ring or a cylinder. The magnets may have dimensions (i.e., length, thickness, width) on the order of millimeters or centimeters (e.g., greater than 0.1 mm such as 0.1 mm to 100 cm). It should be understood that other shapes and dimensions may be suitable and the specific shape and dimensions may depend, in part, on the application in which the magnet is used.

As noted above, the techniques described herein involve coating the magnet. The coating may include only one layer (i.e., the aluminum manganese alloy layer). In other embodiments, the coating may include multiple layers, as described further below. In some cases, the coating may be formed on at least a portion of the outer surface of the magnet. In other cases, the coating covers the entire outer surface of the magnet.

When a layer is referred to as being “on,” “over,” or “overlying” another structure (e.g., magnet, another layer), it can be directly on the structure, or an intervening structure (e.g., another layer) also may be present. A layer that is “directly on” or “in direct contact with” another structure means that no intervening structure (e.g., another layer) is present. It should also be understood that when a structure is referred to as being “on” or “over” another structure, it may cover the entire structure, or a portion of the structure.

The coating includes an aluminum manganese alloy layer. The inventors have appreciated that a manganese concentration of less than or equal to 12 atomic % (e.g., less than 12 atomic % or between 0.5 atomic % and 12 atomic %) is important to produce high quality coatings that impart the coated magnets with enhanced corrosion resistance and ductility. In some embodiments, a manganese concentration between 0.5 atomic % and 10 atomic % may be particularly preferred. In some embodiments, a manganese concentration between 2 atomic % and 12 atomic %; or, between 2 atomic % and 10 atomic % may be preferred.

In some cases, the aluminum manganese alloy layer may have a particular microstructure. For example, the aluminum manganese alloy layer (and/or other layer(s) of the coating) may have a nanocrystalline microstructure. As used herein, a “nanocrystalline” structure refers to a structure in which the number-average size of crystalline grains is less than one micron. The number-average size of the crystalline grains provides equal statistical weight to each grain and is calculated as the sum of all spherical equivalent grain diameters divided by the total number of grains in a representative volume of the body. The number-average size of crystalline grains may, in some embodiments, be less than 100 nm; and, in some embodiments, less than 50 nm. In some cases, the aluminum manganese alloy has a number-average grain size less than 50% of a thickness of the aluminum manganese alloy layer. In some instances, the number-average grain size may be less than 10% of a thickness of the aluminum manganese alloy layer. In some embodiments, the aluminum manganese alloy may have an amorphous structure. As known in the art, an amorphous structure is a non-crystalline structure characterized by having no long range symmetry in the atomic positions. Examples of amorphous structures include glass, or glass-like structures.

In some embodiments, the aluminum manganese alloy may be a solid solution where the metals comprising the layer are essentially dispersed as individual atoms. In some embodiments, the manganese is a saturated (e.g., supersaturated) solution in aluminum. In embodiments in which the alloy is a solid solution, the layer may be free of intermetallic species (e.g., Al—Mn intermetallic species). It is believed that such solid solutions may contribute to enhancing ductility and corrosion resistance. Such a structure may be produced using an electrodeposition process, as described further below. In some cases, the solid solution may be essentially free of oxygen.

As noted above, the coating may include additional layers. The layers may be on and/or below the aluminum manganese alloy layer.

In some embodiments, the coating further includes a layer comprising nickel such as pure Ni metal or a Ni-based alloy (e.g., Ni—P). The layer comprising nickel may be formed under the aluminum manganese alloy layer. That is, the layer comprising nickel may be formed between the magnet and the aluminum manganese layer. Other suitable compositions for additional layers (e.g., a layer formed under the aluminum manganese layer) include Al, Cu, Sn and Zn metals, as well as their alloys.

The coating and/or each layer of the coating may have any suitable thickness. In some embodiments, it may be advantageous for a layer to be thin, for example, to save on material costs. For example, the coating and/or layer thickness may be less than 1000 microinches (e.g., between about 1 microinch and about 1000 microinches; in some cases, between about 50 microinches and about 750 microinches); in some cases the layer thickness may be less than 750 microinches (e.g., between about 1 microinch and about 750 microinches; in some cases, between about 50 microinches and about 500 microinches); and, in some cases, the layer thickness may be less than 500 microinches (e.g., between about 1 microinch and about 500 microinches; in some cases, between about 5 microinches and about 50 microinches). It should be understood that other layer thicknesses may also be suitable.

Advantageously, the coating and/or layer(s) (e.g., the aluminum manganese alloy layer) of the coating may be thermally stable. Thus, the coating and/or layer(s) maintain stable structure and properties over time during use (e.g., at elevated temperatures). In some cases, the coating and/or layer(s) (e.g., the aluminum manganese alloy layer) exhibit little or no change in grain size upon exposure to elevated temperatures for a substantial period of time. In some cases, the grain size changes by no more than about 30 nm, no more than about 20 nm, no more than about 15 nm, no more than about 10 nm, or no more than about 5 nm following exposure to a temperature of at least 125° C. for at least 1000 hours. These thermal stability values are achievable under other suitable conditions, for example, at about 150° C. for at least about 24 hours, at about 200° C. for at least about 24 hours, at about 250° C. for at least about 24 hours, or at about 200° C. for at least about 120 hours.

Those of ordinary skill in the art will be aware of suitable methods to determine the thermal stability of a material. In some cases, the thermal stability may be determined by observing microstructural changes (e.g., grain growth, phase transition, etc.) of a material during and/or prior to and following exposure to heat. Thermal stability may be determined using differential scanning calorimetry (DSC) or differential thermal analysis (DTA), wherein a material is heating under controlled conditions. To determine changes in grain size and/or phase transitions, in situ x-ray experiments may be conducting during the heating process.

As noted above, layer(s) of the coating may be formed using an electrodeposition (also referred to as an electroplating process). In some cases, each layer of the coating may be applied using a separate electrodeposition bath. In general, during an electrodeposition process an electrical potential may exist on the substrate to be coated, and changes in applied voltage, current, or current density may result in changes to the electrical potential on the substrate. In some cases, the electrodeposition process may include the use of waveforms comprising one or more segments, wherein each segment involves a particular set of electrodeposition conditions (e.g., current density, current duration, electrodeposition bath temperature, etc.). The waveform may have any shape, including square waveforms, non-square waveforms of arbitrary shape, and the like. In some methods, such as when forming coatings having different portions, the waveform may have different segments used to form the different portions. However, it should be understood that not all methods use waveforms having different segments.

In some embodiments, a coating, or portion thereof, may be electrodeposited using direct current (DC) deposition. For example, a constant, steady electrical current may be passed through the electrodeposition bath to produce a coating, or portion thereof, on the substrate. In some embodiments, the potential that is applied between the electrodes (e.g., potential control or voltage control) and/or the current or current density that is allowed to flow (e.g., current or current density control) may be varied. For example, pulses, oscillations, and/or other variations in voltage, potential, current, and/or current density, may be incorporated during the electrodeposition process. In some embodiments, pulses of controlled voltage may be alternated with pulses of controlled current or current density. In some embodiments, the layer(s) may be formed (e.g., electrodeposited) using pulsed current electrodeposition, reverse pulse current electrodeposition, or combinations thereof.

In some cases, a bipolar waveform may be used, comprising at least one forward pulse and at least one reverse pulse, i.e., a “reverse pulse sequence.” In some embodiments, the at least one reverse pulse immediately follows the at least one forward pulse. In some embodiments, the at least one forward pulse immediately follows the at least one reverse pulse. In some cases, the bipolar waveform includes multiple forward pulses and reverse pulses. Some embodiments may include a bipolar waveform comprising multiple forward pulses and reverse pulses, each pulse having a specific current density and duration. In some cases, the use of a reverse pulse sequence may allow for modulation of composition and/or grain size of the coating that is produced.

Those of ordinary skill in the art would recognize that the electrodeposition processes described herein are distinguishable from electroless processes which primarily, or entirely, use chemical reducing agents to deposit the coating, rather than an applied voltage. The electrodeposition baths described herein may be substantially free of chemical reducing agents that would deposit coatings, for example, in the absence of an applied voltage.

In some embodiments, a barrel electroplating process is used to deposit one or more layer(s) of the coating (e.g., the aluminum manganese alloy layer). In general, the barrel plating processes described herein involve loading many small magnets to be coated into a barrel. The barrel plating apparatus is configured such that the magnets are in contact with an electroplating bath. As described further below, the bath includes appropriate chemical species including metal ionic species (e.g., aluminum ionic species and manganese ionic species) which are deposited in the form of an alloy (e.g., aluminum and manganese) during the plating process. In some cases, the barrel is placed in the bath (which may be contained in a tank) and perforations in the barrel walls enable the bath to contact the components.

Within the barrel, the magnets are in electrical contact with one or more other components. An electrical lead (also referred to as a “dangler”) extends within the volume of the barrel and contacts at least some the magnets during use. The lead is connected to a power supply so that it can function as a “barrel” electrode used in the electrodeposition process to provide electrical current to the magnets. The electrical lead, also referred to as a “dangler”, can be a conductive wire such as a metal wire, or a series of metal wires in electrical contact with one another. The electrical lead can also be a conductive rod or other geometry of conductive material, or an assembly of many such geometries. In some cases, functional geometries are part of the electrical lead as in the case of mechanical clips, clamps, screws, hooks, or brushes which facilitate electrical contact with components. The electrical lead need not be stationary, but can move due to the agitation of the process. For example, the electrical lead can be coupled to the barrel.

The barrel coating apparatus can include a “bath” electrode which is in contact with the electroplating bath. For example, the bath electrode may be immersed in the bath. During plating, a voltage is applied between the barrel and bath electrodes using the power supply. The electrical current passes from the power supply through the barrel electrode, and into the magnets with which it is in contact and to the other magnets in the barrel via the physical contacts between the magnets. As the barrel rotates, a substantial portion of the magnets are in contact with one another and, thus, function as a single electrode. As a result of the potential on the magnets, metal ionic species (e.g., aluminum ionic species, manganese ionic species) in the bath are reduced on the magnet surfaces and deposit in the form of a layer on the magnets.

In general, the baths include suitable metal sources for depositing a layer with the desired composition. For instance, when depositing a metal alloy, it should be understood that all of the metal constituents in the alloy have sources in the bath. The metal sources are generally ionic species that are dissolved in the fluid carrier. As described above, during the electrodeposition process, the ionic species are deposited in the form of a metal alloy to form the coating. In general, any suitable ionic species can be used. In some embodiments, electrodeposition bath comprising aluminum ionic species, manganese ionic species, an ionic liquid, and at least one type of additive. In some embodiments, the electrodeposition bath comprises an organic co-solvent. The organic co-solvent may be used to reduce the viscosity of the ionic liquid electrolyte, improve the conductivity of the ionic liquid electrolyte, improve electrodeposition rates, improve the deposit appearance, and/or reduce dendritic growth.

Those of ordinary skill in the art would be able to select the appropriate combination of bath components suitable for use in a particular application. Generally, the additives in a bath are compatible with electrodeposition processes, i.e., a bath may be suitable for electrodeposition processes.

Certain suitable baths and plating processes for depositing aluminum manganese alloy layers have been described in commonly-owned U.S. Patent Publication No. 2014-0272458, which is incorporated herein by reference in its entirety.

As noted above, the coated magnets have desirable properties including corrosion resistance and ductility. The ductility enables the coated magnets to have good thermal shock resistance and/or thermal cycling without cracking. The coated magnets may be used in a variety of applications including, but not limited to, portable electronic devices, head actuators for computer hard disks, magnetic resonance imaging (MRI), magnetic guitar pickups, loudspeakers and headphones, magnetic bearings and couplings, permanent magnet motors, cordless tools, servo motors, lifting and compressor motors, synchronous motors, spindle and stepper motors, electrical power steering, drive motors for hybrid and electric vehicles, actuators, and magnetic clasps.

The following examples are for illustrative purposes and should be considered to be non-limiting.

### EXAMPLE 1

This example illustrates the excellent performance of an Al—Mn alloy coating on NdFeB magnets.

An Al—Mn including 6 atomic % Mn was electroplated on magnets made from NdFeB. The coatings had a nanocrystalline grain size. The coatings of Al—Mn were nominally 10 microns thick, covering all sides of the rectangular prism magnet. The magnets were exposed to various test environments and shown to have the following performance characteristics:

Salt Spray: Magnets exposed to 24 hours of salt spray exposure as per ASTM B-117 test method showed no indications of red rust formation.

Acid vapor: Magnets exposed to acidic vapor at 60° C. for 500 hours showed no indications of red rust formation. (Test method described in J. Electrochem. Soc., Vol. 145, No. 12, December 1998 which is incorporated herein by reference in its entirety).

Thermal Shock: Magnets exposed to thermal shock showed no evidence of cracking. Thermal shock was performed by soaking magnets at 250° C. for 5 minutes then quenching the parts to room temperature in water.

Thermal Cycling: Magnets were exposed to cycling from 85° C. to −40° C., for 20 cycles, and showed no evidence of cracking.

### EXAMPLE 2

This example illustrates the excellent performance of a coating on NdFeB magnets which included an Al—Mn layer on an Al layer.

An Al—Mn coating including 6 atomic % Mn was electroplated to a thickness of 5 microns on a commercially pure Al layer to form a coating on top of magnets made from NdFeB. The coatings had a nanocrystalline grain size. The total coatings were nominally 10 microns thick, covering all sides of the rectangular prism magnet. The magnets were exposed to various test environments and shown to have the following performance characteristics:

Salt Spray: Magnets exposed to 96 hours of salt spray exposure as per ASTM B-117 test method showed no indications of red rust formation.

Acid vapor: Magnets exposed to acidic vapor at 60 C for 1000 hours showed no indications of red rust formation.

Thermal Shock: Magnets exposed to thermal shock showed no evidence of cracking. Thermal shock was performed by soaking magnets at 250 C for 5 minutes then quenching the parts to room temperature in water.

Thermal Cycling: Magnets were exposed to cycling from 85 C to −40 C, for 20 cycles, and showed no evidence of cracking.

### EXAMPLE 3

This example illustrates the effect of varying the Mn content of an Al—Mn alloy coating.

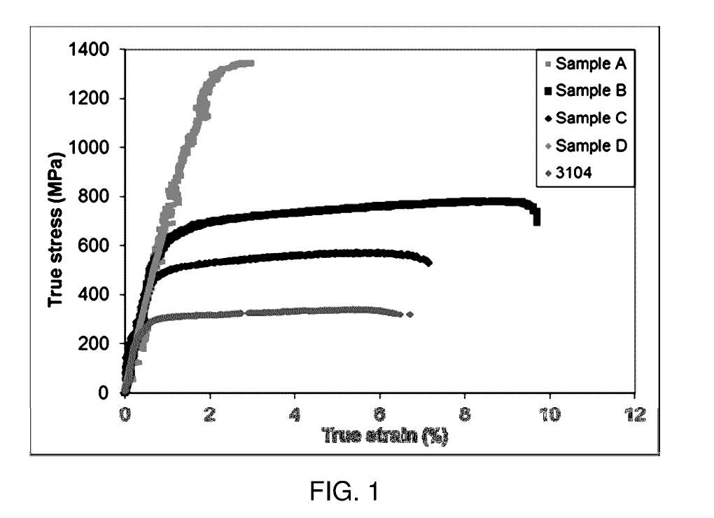

Four alloys of Al—Mn were created with varying Mn content. The Mn content varied from 5 to 13 atomic %. Sample A had a Mn content of 12 atomic %, sample B had a Mn content of 8 atomic %, Sample C had a Mn content of 5 atomic % and Sample D had a Mn content of 13 atomic %. These coatings were then tested by uniaxial tensile testing using a subsize sample as per ASTM E-8 and compared to a standard aluminum alloy, AA3104 (lowest curve on graph). FIG. 1 shows the true stress vs. true strain curve for the samples.

Both the strength and ductility of the alloys were correlated to the Mn content. Samples B (fractured at a strain of about 10%) and C (fractured at a strain of about 7%) which were nanocrystalline, showed good toughness and significant ductility. Sample A (fractured at a strain of about 3%) is a mixture of nanocrystalline and amorphous materials. It has high strength but limited ductility. This makes this alloy at the highest end of Mn content that would produce desirable mechanical properties for the coating in certain applications. Sample D has the highest Mn content and as is completely amorphous in its crystal structure. It is completely brittle and would crack during thermal shock testing or mechanical handling. Cracks in the coating expose the nascent NdFeB material underneath when can then rapidly corrode.

What is claimed:

1. An article, comprising:
a magnet; and
a coating formed on the magnet, the coating including an aluminum manganese alloy layer including a manganese concentration of less than or equal to 12 atomic %.

2. The article of claim 1, wherein the manganese concentration of the aluminum manganese alloy layer is between 0.5 atomic % and 12 atomic %.

3. The article of claim 1, wherein the magnet comprises a rare earth magnetic material.

4. The article of claim 1, wherein the rare earth magnetic material comprises neodymium.

5. The article of claim 1, wherein the rare earth magnetic material further comprises iron and boron.

6. The article of claim 1, wherein the magnet comprises a material selected from the group consisting of Nd₂Fe₁₄B, Nd₉Fe₈₆B₅, SmCo₅, AlNiCo, and NiFe.

7. The article of claim 1, wherein the aluminum manganese alloy includes a manganese concentration of between 0.5 atomic % and 10 atomic %.

8. The article of claim 1, wherein the coating includes a single layer, the single layer comprising the aluminum manganese alloy.

9. The article of claim 1, wherein the coating includes multiple layers.

10. The article of claim 1, wherein the coating further includes a layer comprising nickel.

11. The article of claim 1, wherein the layer comprising nickel is formed under the aluminum manganese alloy layer.

12. The article of claim 1, wherein the coating further comprises a layer comprising a composition selected from the group consisting of Ni, Cu, Ni—P, Sn, Zn, and combinations thereof.

13. The article of claim 1, wherein the coating includes a metal layer formed over the aluminum manganese layer.

14. The article of claim 1, wherein the aluminum manganese alloy layer has an average grain size of less than 1 micron.

15. The article of claim 1, wherein the aluminum manganese alloy layer has an average grain size of less than 100 nm.

16. The article of claim 1, wherein the aluminum manganese alloy layer is formed using an electrodeposition process.

17. The article of claim 1, wherein the aluminum manganese alloy is a solid solution.

18. A method of forming a coating on an article comprising:
electroplating a coating on a magnet, the coating including an aluminum manganese alloy layer including a manganese concentration of less than or equal to 12 atomic %.

19. The method of claim 18, wherein the manganese concentration of the aluminum manganese alloy layer is between 0.5 atomic % and 12 atomic %.

20. The method of claim 18, further comprising:
loading a barrel with a plurality of magnets;
rotating the barrel in an electroplating bath; and
electroplating the coating on the magnets.

21-36. (canceled)
